(19) United States
(12) Patent Application Publication
(10) Pub. No.: US 2025/0058994 A1
(43) Pub. Date: Feb. 20, 2025

(54) CABLE HOLDER CASE FOR ELECTRICALLY DRIVEN VEHICLES

(71) Applicant: RMG INDUSTRIAL ADVANCE S.R.L., Casalmaggiore (CR) (IT)

(72) Inventor: Giuseppe SIMONAZZI, Casalmaggiore (CR) (IT)

(21) Appl. No.: 18/721,586

(22) PCT Filed: Nov. 29, 2022
(86) PCT No.: PCT/IB2022/061539

§ 371 Date: Jun. 18, 2024

(30) Foreign Application Priority Data
Dec. 20, 2021 (IT) 102021000031841

(51) Int. Cl. B65H 75/40; B60L 53/18; B65H 75/44

(52) U.S. Cl. CPC B65H 75/40; B60L 53/18; B65H 75/4449; B65H 75/4471; B65H 2701/34

(57) ABSTRACT

The cable holder case (1) for vehicles comprises a transportable container (2) resting on the ground and defining a containment compartment (3 a, 3b) inside it. a single cable (5) for electrically charging electrically driven vehicles which is housed at least partly inside the compartment (3a, 3b) in a winding and unwinding manner and comprises two movable ends (6, 7) located externally to the compartment (3 a, 3b), of which a first end (6) provided with a first connector (8) connectable to an electric charging device (D), and a second end (7). opposite the first end (6), provided with a second connector (9) connectable to an inlet (P) of an electrically driven vehicle (A), and winding/unwinding means (13) which are associated with the container (2) and are adapted to wind and unwind the cable (5).

### TECHNICAL FIELD

The present invention relates to a cable holder case for electrically driven or plug-in hybrid vehicles.

### BACKGROUND ART

As is well known, Battery Electric Vehicles (BEVs, the internationally recognized acronym) use chemical energy stored in one or more rechargeable batteries as their primary energy source and made available by those batteries to the motorized unit in the form of electrical energy.

Similarly, plug-in hybrid electric vehicles (PHEVs, the internationally recognized acronym) also have an on-board battery that can be charged not only by the on-board internal combustion engine but also by the power grid.

In both cases, for the purpose of periodically charging the batteries, the aforementioned vehicles are provided with one or more charging cables approved by the manufacturer and supplied with the vehicle itself when it is purchased.

The aforementioned charging cables, supplied inside the vehicle as a result of a customer's purchase, are approved directly by car manufacturers according to international standards such as, e.g., the IEC 62196 Type 2 standard (Mennekes).

This approval mentioned above is essential to ensure the safe functionality of the cable itself.

In the present case, these cables comprise a first end provided with a special first connector which can be connected to an electric power source, such as e.g. the type of an electric column, and with a second end, opposite the former, fitted with a special second connector which can be directly connected to the electric or electrified vehicle to be charged.

By connecting the two connectors in this manner, it is, therefore, possible to connect the battery to the power source and, thus, to charge the vehicle.

In this regard, it should be borne in mind that the transfer of electrical energy takes place, in this circumstance, at particularly high voltages and powers that evidently require the construction of charging cables with peculiar technical-structural characteristics.

In particular, the charging cables are provided with a considerable diameter and such, specifically, as to allow electricity to flow efficiently and safely from one end of the cable to the other.

Specifically, the diameter of the cable varies depending on the maximum electrical power that can be transmitted by the same; in this sense, the diameter and, therefore, the weight of the cable cannot drop below a certain limit value in order to ensure that electrical charging takes place safely.

This structural characteristic, while justified by the technical requirements outlined, poses a lot of logistical and utilization problems that ultimately result in major drawbacks.

In fact, the weight of such cables makes them particularly difficult to handle and store in the vehicle (e.g., in the trunk) once used, thus complicating their handling by the user.

On the other hand, with regard to the cable length, there is no universally adopted standard in this regard; therefore, cables are generally supplied by automakers with relatively short lengths for reasons of better handling and economy.

However, it is easy to appreciate that an excessively short cable can bring inconvenience to the user, who must necessarily place his or her vehicle a short distance from the electric charging device.

That said, it is important to specify that using longer charging cables (e.g., up to 9 meters) does not prove to be an inconvenience-free solution either.

Because of their considerable extension, in fact, such cables rest on the ground for a fair part of their length when charging the vehicle and, as they crawl on the ground, they end up getting dirty.

This fact is particularly inconvenient because dirty charging cables are responsible for soiling both to the user, who must necessarily rewind the cable before storing it, and to the interior of the car, requiring cleaning and disinfection of all surfaces in contact with the cables themselves.

Not only that, but the considerable length of the cables results in frequent knotting which, in addition to necessitating inconvenient unraveling, can lead to damage to the cables themselves, resulting in their premature end of life and endangering the safety of the user.

All this being said, it is known in the state of the art that patent document IT201900016175 describes a device adapted to enable the winding and unwinding of cables for charging electric vehicles.

In this regard, while promoting the handling of the electrical cable, the device described in patent document IT201900016175 is amenable to refinement.

In the present case, the specific internal structure of the enclosure and the small size are problematic if it is necessary to accommodate and use large-diameter cables such as those normally used for charging at high powers.

In particular, when using a single cable with a large diameter, the pronounced bending angle of the folded stretch between the first coil and the second coil can lead to excessive stress and, therefore, damage to the cable itself.

Specifically, the reel described in this document does not allow the simple use of charging cables normally found inside the car trunk, which are approved directly by car manufacturers according to international standards such as, e.g., the IEC 62196 Type 2 standard, without the need for any additional approval.

In fact, the specific internal structure and conformation of the described reel requires the use of specific cables suitably modified or, at any rate, the use of small-diameter cables normally used for low-power charging from the home grid, thus inside homes. Therefore, the use of a reel with built-in cable, such as the one described, necessarily requires a major approval process to enable its safe use.

In addition to this, the special conformation of the outer enclosure and the specific winding/unwinding securing/releasing system can be improved in order to enable easier and faster use in all charging situations.

In addition, the construction of the entire device and, in particular, of the enclosure and of the winding and unwinding system housed therein is quite complex, resulting in non-negligible construction costs.

### DESCRIPTION OF THE INVENTION

The main aim of the present invention is to devise a compact, easily transportable cable holder case for vehicles which allows simplifying handling, connecting and disconnecting operations of the electric cable during the electric vehicle charging operations.

One object of the present invention is to devise a cable holder case for electrically driven vehicles which allows maintaining the cable clean during the entire charging operation.

Another object of the present invention is to devise a cable holder case for electrically driven vehicles which can be easily housed inside the trunk or special compartments.

Another object of the present invention is to devise a cable holder case for vehicles capable of easily housing a standard charging cable, such as an IEC 62196 Type 2 (Mennekes) approved cable, inside it, ensuring all electro-mechanical performance established by the cable manufacturer and/or during approval.

Therefore, the object of this invention is to allow the simple use of charging cables normally found inside the trunk of the car, directly approved by car manufacturers according to international standards such as, e.g., the IEC 62196 Type 2 standard, without the need for any additional approval.

An additional object of the present invention is to devise a cable holder case for vehicles which allows lowering the rate of cable wear and tear, ensuring the latter the full life established in the approval process.

A further object of the present invention is to devise a cable holder case for electrically driven vehicles with simplified construction and easy and effective use.

Another object of the present invention is to devise a cable holder case for electrically driven vehicles that can overcome the aforementioned drawbacks of the prior art within the framework of a simple, rational, easy and effective to use as well as cost-effective solution.

The aforementioned objects are achieved by this cable holder case for electrically driven vehicles having the characteristics of claim 1.

### BRIEF DESCRIPTION OF THE DRAWINGS

Other characteristics and advantages of the present invention will become more apparent from the description of a preferred, but not exclusive, embodiment of a cable holder case for electrically driven vehicles, illustrated by way of an indicative, yet non-limiting example, in the accompanying tables of drawings in which:

FIG. 1 is an overall axonometric view of a first embodiment of case making according to the invention;

FIG. 2 shows an application example of using the case according to the invention;

FIG. 3 is an exploded view of the case according to the invention in accordance with the first embodiment;

FIG. 4 is an axonometric view, in partial section, of the case according to the invention in accordance with the first embodiment;

FIG. 5 is an overall axonometric view of a second embodiment of case making according to the invention;

FIG. 6 is an exploded view of the case according to the invention in accordance with the second embodiment;

FIG. 7 is a sectional side view of the case according to the invention in accordance with the second invention;

FIG. 8 is a sectional view, carried out along the VIII-VIII plane, of FIG. 7;

FIG. 9 is an axonometric view, in partial section, of the case according to the invention in accordance with the second embodiment.

### EMBODIMENTS OF THE INVENTION

With particular reference to these figures, reference numeral 1 globally denotes a cable holder case for electrically driven vehicles.

It is specified that the term “electrically driven vehicle” means, in the context of the present invention, any motorized means of transportation provided with at least one battery intended to power the motor(s) of the vehicle itself.

It follows, then, that the term “electrically driven vehicle” can refer indifferently to any one of: an electric car, an electric motorcycle, an electric agricultural vehicle and so on.

The cable holder case 1 for electrically driven vehicles comprises at least one transportable container 2 resting on the ground and defining at least one containment compartment 3a, 3b inside it.

Specifically, the container 2 is substantially conformed to as a shell.

In this sense, the container 2 comprises at least a first half-shell 2a and at least a second half-shell 2b which can be paired with each other to define the container itself.

In actual facts, the container 2 consists of the first half-shell 2a and of the second half-shell 2b.

This means that the first half-shell 2a and the second half-shell 2b are provided with a first cavity 3a and with at least a second cavity 3b respectively, which define, when the first half-shell 2a and the second half-shell 2b are coupled, the compartment 3a, 3b.

Preferably but not exclusively, the first half-shell 2a and the second half-shell 2b are conformed quite similarly to each other.

Among other things, it is possible to reduce the production costs by making two components that are substantially identical to each other.

Usefully, the first half-shell 2a and the second half-shell 2b are coupled together by means of a plurality of joining elements of the type of screws or the like.

In this sense, it is sufficient to juxtapose the first half-shell 2a to the second half-shell 2b with each other, by pressing them against each other, and to couple the latter with the aforementioned joining elements to define the container 2 and the compartment 3a, 3b.

Alternative embodiments cannot however be ruled out wherein the first half-shell 2a and the second half-shell 2b can be coupled differently, e.g. by means of a threaded coupling or by means of other types of connections still known to the expert in the field.

In addition, the container 2 is preferably made from plastic material.

The choice of this material which is known to be provided with rather low density, makes it possible to obtain a case 1 with low weight that is, therefore, easily handled and transported.

In all cases, making the container 2 from one or more materials other than plastic, such as aluminum, cannot be ruled out.

The case 1 then comprises, at least one handle 4 associated with the container 2 and usable by a user for the transport of the container itself.

In this case, the handle 4 is composed of at least a first gripping portion 4a, associated with the first half-shell 2a, and at least a second gripping portion 4b, associated with the second half-shell 2b.

Preferably, the first gripping portion 4a and the first half-shell 2a are made in one single body piece.

Similarly, the second gripping portion 4b and the second half-shell 2b are made in one single body piece.

It is sufficient to couple the first half-shell 2a and the second half-shell 2b, therefore, to also couple together the first gripping portion 4a and the second gripping portion 4b to define, thus, the handle 4.

The case 1 then comprises a single cable 5 for electrically charging electrically driven vehicles which is housed at least partly inside the compartment 3a, 3b in a winding and unwinding manner and comprises at least two movable ends 6, 7 located externally to the compartment 3a, 3b, of which:
at least one first end 6 provided with at least one first connector 8 connectable to at least one electric charging device D; and
at least one second end 7, opposite the first end 6, provided with at least one second connector 9 connectable to at least one inlet P of at least one electrically driven vehicle A.

For example, the cable 5 meets the IEC 62196 Type 2 (Mennekes) standard for alternating current (AC) charging of electric vehicles.

As for the first connector 8 and the second connector 9, the latter may be, e.g., of “type 2” or other types known to the expert in the field that allow, in any case, the effective and safe transfer of the electric current from the electric charging device D to the vehicle A.

It is worth noting at this point that the case 1 comprises a single electric charging cable 5.

In this regard, in fact, it should be remembered that the electric charging device D delivers electric current at particularly high mains voltages and powers, which are necessary to be able to carry out the electric charging of the vehicle A.

However, these operating conditions may prove to be particularly dangerous if, e.g., electrical current were to be transferred by means of two or more cables 5 connected to each other through connection junctions.

Indeed, in the latter case, the likelihood of malfunctions and/or accidents during electric charging is greatly increased precisely because of the presence of such connection junctions which, evidently, represent points of structural weakening of the cables 5.

In this sense, the fact of providing a single cable 5 (i.e., having no connection junctions) complying with the IEC 62196 Type 2 (Mennekes) standard and, possibly, already approved by the car manufacturers allows for totally safe electric charging of the vehicle A without compromising the rated electrical-mechanical performance and without generating additional stress to the cable during use but, on the contrary, safeguarding it from adverse weather conditions or accidental shocks.

In fact, the container 2 is compatible with externally approved cables (e.g., by the manufacturer or automakers), and the assembly and/or making of the case 1 does not, therefore, impose any changes to the cable 5.

Going into detail, the cable 5 comprises at least a first stretch 10 associated with the first end 6 and at least a second stretch 11 substantially parallel to the first stretch 10 and associated with the second end 7.

Except for a possible difference in length, the first stretch 10 and the second stretch 11 are completely similar to each other from the structural and functional point of view.

Usefully, the cable 5 comprises at least one intermediate stretch 12 positioned between the first stretch 10 and the second stretch 11.

The intermediate stretch 12 has considerably less length than the first stretch 10 and the second stretch 11, e.g., in the order of centimeters.

In addition, the case 1 comprises winding/unwinding means 13 which are associated with the container 2 and are adapted to wind and unwind the cable 5.

Specifically, the winding/unwinding means 13 comprise at least one winding/unwinding member 14 on which the cable 5 is wound which is associated with the container 2 in a rotatable manner around at least one winding/unwinding axis R of the cable 5.

In the present case, the winding/unwinding member 14 is rotatable around the winding/unwinding axis R in a first direction of rotation, in which the cable 5 is wound on the winding/unwinding member 14, and in a second direction of rotation, opposite the previous one, in which the cable 5 is unwound from the winding/unwinding member 14.

In actual facts, the winding/unwinding member 14 rotates in one or the other direction around the winding/unwinding axis R depending on whether the cable 5 is wound/unwound on/from the winding/unwinding body itself.

Specifically, the winding/unwinding member 14 is rotatable around the winding/unwinding axis R between at least one configuration of maximum winding of the cable 5 and at least one configuration of maximum unwinding of the cable 5.

It is easy to infer, then, that in the switch from the configuration of maximum winding to the configuration of maximum unwinding the first connector 8 and the second connector 9 can be arranged at a progressively greater relative distance, until they can be arranged at the maximum relative distance at the configuration of maximum unwinding.

Usefully, the winding/unwinding member 14 comprises at least one housing area 16 on which the first stretch 10 and the second stretch 11 are wound.

Preferably, the housing area 16 is conformed substantially as a hollow cylinder.

Specifically, the winding/unwinding axis R is superimposed with the geometric axis (i.e., the axis of revolution of the cylinder) of the housing area 16.

In other words, the winding/unwinding member 14 is of the type of a spool provided with a cylindrical portion on which the first stretch 10 and the second stretch 11 are wound, which corresponds to the housing area 16.

Usefully, the first stretch 10 and the second stretch 11 define on the housing area 16 a plurality of winding coils the number of which increases if the cable 5 is wound on the winding/unwinding member 14 and the number of which, on the contrary, decreases if the cable 5 is unwound from the winding/unwinding member 14.

It is worthy, in this regard, to highlight that the particular way in which the first stretch 10 and the second stretch 11 are wound and unwound on the housing area 16 means that the latter are always wound and unwound by the same amount.

By way of example, if one of either the first end 6 or the second end 7 is pulled, the winding/unwinding member 14 is set in rotation around the winding/unwinding axis R in the second direction of rotation, and, as a result, the first stretch 10 and the second stretch 11 are unwound together by the same amount.

As will be explained in detail below, this particular expedient proves peculiar in ensuring easy and at the same time particularly effective operation of the case 1.

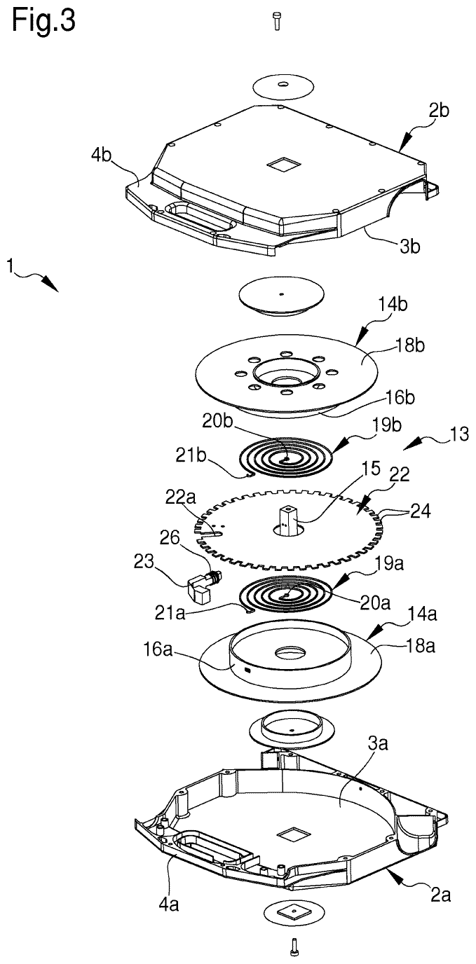

Moreover, as visible in FIG. 3, the winding/unwinding member 14 comprises at least a first winding/unwinding element 14a and at least a second winding/unwinding element 14b coupled to the first winding/unwinding element 14a to define the winding/unwinding member 14.

In actual facts, the winding/unwinding member 14 consists of the first winding/unwinding element 14a and of the second winding/unwinding element 14b.

In detail, the first winding/unwinding element 14a and the second winding/unwinding element 14b can be coupled together in integral rotation around the winding/unwinding axis R.

In particular, the first winding/unwinding element 14a and the second winding/unwinding element 14b have substantially the same conformation.

In this regard, the first winding/unwinding element 14a and the second winding/unwinding element 14b comprise at least a first discoidal portion 18a and at least a second discoidal portion 18b, respectively.

In addition, the first winding/unwinding element 14a and the second winding/unwinding element 14b comprise at least a first circular crown portion 16a associated with the first discoidal portion 18a and at least a second circular crown portion 16b associated with the second discoidal portion 18b, respectively.

In particular, the maximum diameter of the first circular crown portion 16a and of the second circular crown portion 16b are smaller than the maximum diameter of the first discoidal portion 18a and of the second discoidal portion 18b.

The discoidal portions 18a, 18b are associated with the respective circular crown portions 16a, 16b in such a way that, once the first winding/unwinding element 14a and the second winding/unwinding element 14b are coupled together, the circular crown portions themselves are positioned between the first discoidal portion 18a and the second discoidal portion 18b.

In this regard and according to the preferred embodiment shown in the figures, the housing area 16 comprises at least a first housing portion 16a on which the first stretch 10 is wound and at least a second housing portion 16b, alongside the first housing portion 16a, on which the second stretch 11 is wound.

In other words, on the first housing portion 16a only the first stretch 10 is wound, and on the second housing portion 16b only the second stretch 11 is wound.

Preferably, the first housing portion 16a coincides with the first circular crown portion 16a and the second housing portion 16b coincides with the second circular crown portion 16b.

This means that the first circular crown portion 16a and the second circular crown portion 16b together define the housing area 16.

In this sense, therefore, it is easy to appreciate that the housing area 16 is positioned between the first discoidal portion 18a and the second discoidal portion 18b.

In other words, as previously anticipated, the first discoidal portion 18a and the second discoidal portion 18b bound the housing area 16.

As visible in FIG. 3, the winding/unwinding means 13 comprise return means 19a, 19b associated with the winding/unwinding member 14 and adapted to arrange the latter in the configuration of maximum winding.

Specifically, the return means 19a, 19b comprise at least one return element 19a, 19b which is elastically deformable by traction and is provided with at least one fixed portion 20a, 20b, associated with the container 2, and with at least one movable portion 21a, 21b, opposite the fixed portion 20a, 20b, associated with the housing area 16 and movable between the configuration of maximum winding and the configuration of minimum winding.

In this regard, the case 1 comprises a pin 15 with which the fixed portion 20a, 20b is associated.

In detail, the pin 15 has respective slots into which the fixed portion 20a, 20b is fitted.

Specifically, the pin 15 is arranged so as to be substantially superimposed on the winding/unwinding axis R.

Again, the pin 15 has a substantially prismatic conformation. p In the present case, the pin 15 is substantially conformed to a prism having a rectangular base.

Again, the pin 15 is passing through the geometric center of the winding/unwinding member 14.

It is easy to appreciate that making a return element 19a, 19b from elastically deformable material allows the latter to stretch to an extent proportional to the unwinding of the cable 5.

Therefore, by providing a fixed portion 20a, 20b, the return element 19a, 19b can be deformed as a result of the unwinding of the cable 5 and can, therefore, exert a greater elastic return force on the winding/unwinding member 14 the more the cable 5 is unwound by the winding/unwinding member 14.

The use of the return elements 19a, 19b of the so-called “constant force” spring type cannot however be ruled out.

Among other things, this ensures greater continuity in the return of the cable 5.

Preferably, the return element 19a, 19b is of the type of a spring.

In detail, the return element 19a, 19b is of the type of a strip spring. The return elements 19a, 19b of different types, e.g. of the type of a cylindrical profile helical spring, cannot in all cases be ruled out.

Providing for return means 19a, 19b allows, therefore, the cable 5 to be wound onto the winding/unwinding member 14 fully automatically and immediately due to the elastic return force exerted by the return element 19a, 19b on the winding/unwinding member itself.

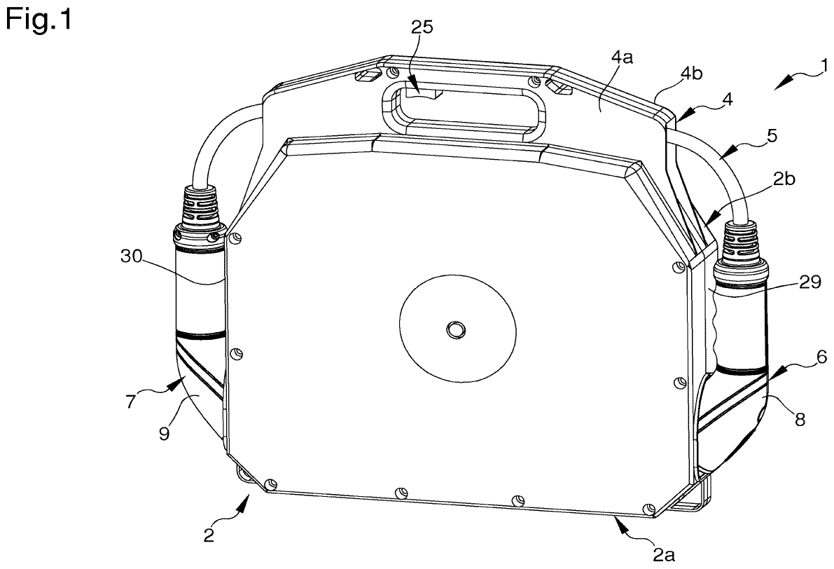

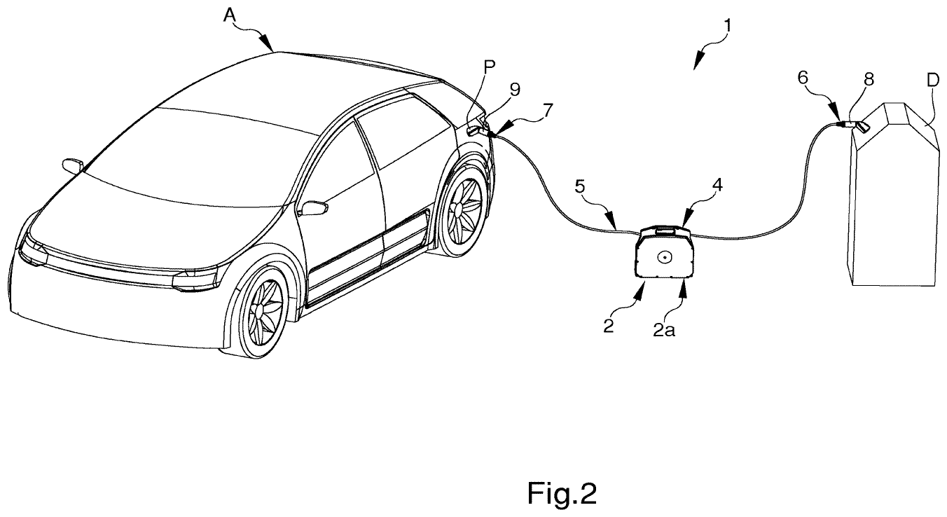

In a first embodiment of the case 1 shown in FIGS. 1 through 4, the return element 19a, 19b is directly housed in the container 2, i.e., the case 1 has no components positioned between the return element 19a, 19b and the container itself.

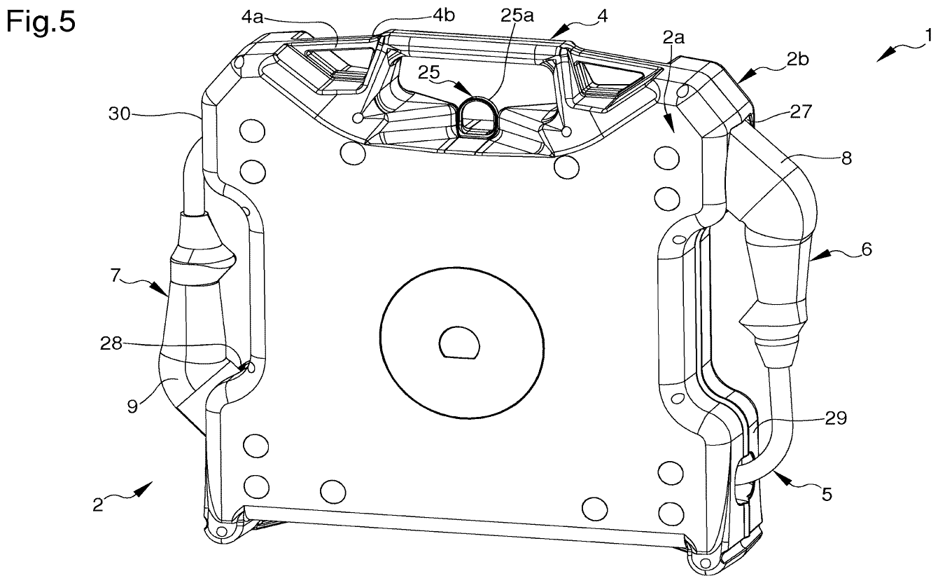

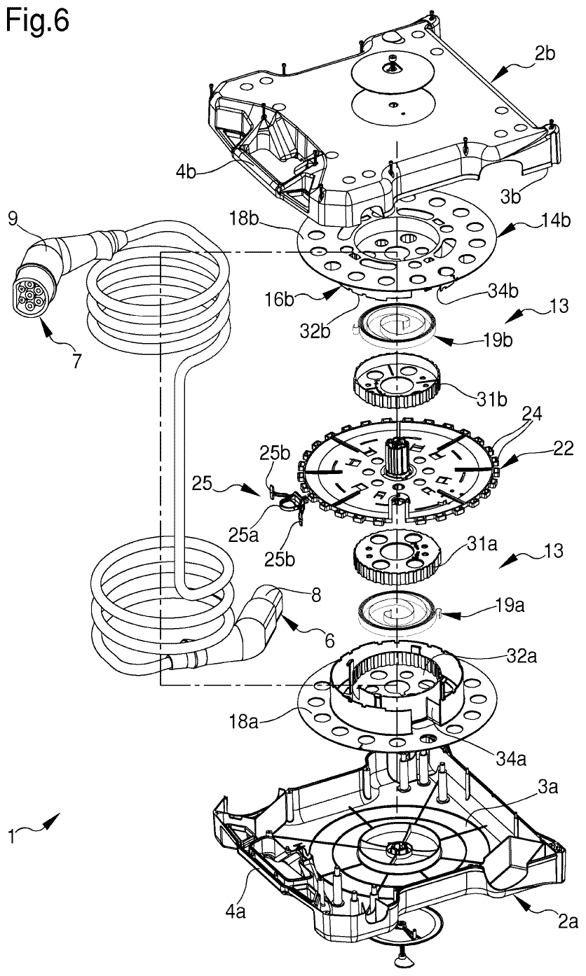

Alternatively, in a second embodiment of the case 1 shown in FIGS. 5 through 9, the case 1 comprises at least one containment member 31a, 31b of the return element 19a, 19b (see FIG. 6).

In this regard, the container 2 defines at least one seat 32a, 32b of the containment member 31a, 31b.

As visible in the above figure, the containment member 31a, 31b has substantially discoidal conformation.

Similarly, the seat 32a, 32b is also conformed substantially discoidal.

Precisely, the containment member 31a, 31b is housed substantially to size in the seat 32.

Again, the containment member 31a, 31b and the seat 32a, 32b are centered with respect to the winding/unwinding axis R.

It is emphasized that providing for a containment member 31a, 31b of the return element 19a, 19b and a corresponding seat 32a, 32b on the winding/unwinding member 14 turns out to be a particularly advantageous technical expedient.

In fact, this expedient greatly promotes the assembly phase of the case 1 and, as a direct consequence, reduces the time with which the latter can be built, thereby reducing production time and costs.

In accordance with the preferred embodiment, the return means 19a, 19b comprise a first return element 19a which is associated with the first winding/unwinding element 14a and a second return element 19b which is associated with the second winding/unwinding element 14b.

More specifically, the first return element 19a is provided with at least a first fixed portion 20a, associated with the rotational pin 15, and at least a first movable portion 21a, opposite the first fixed portion 20a, associated with the first housing portion 16a.

Similarly, the second return element 19b is provided with at least a second fixed portion 20b, associated with the rotational pin 15, and at least a second movable portion 21b, opposite the second fixed portion 20b, associated with the second housing portion 16b.

In this regard, the case 1 comprises two containment members 31a, 31b, of which a first containment member 31a containing the first return element 19a to size and a second containment member 31b containing the second return element 19b to size.

Similarly, the winding/unwinding member 14 defines two seats 32a, 32b, of which a first seat 32a for housing the first containment member 31a and a second seat 32b for housing the second containment member 31b.

Specifically, the first seat 32a is defined on the first half-shell 2a, while the second seat 32b is defined on the second half-shell 2b.

That said, it is specified that providing for both a first return element 19a and a second return element 19b evidently allows the elastic return force to be distributed evenly over the housing area 16, by winding the cable 5 smoothly and efficiently.

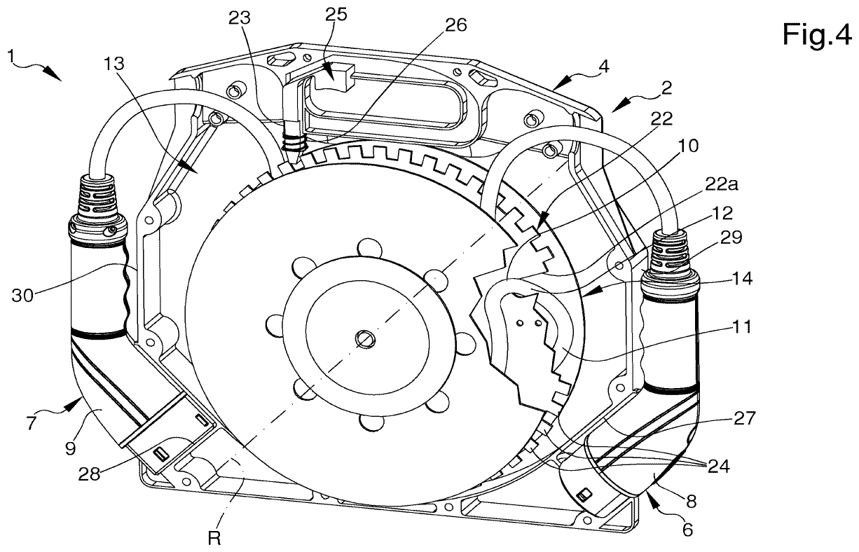

In addition, as shown in FIGS. 3 and 4, the winding/unwinding means 13 comprise securing means 22, 23 for securing the rotation of the winding/unwinding member 14 around the winding/unwinding axis R.

In particular, the securing means 22, 23 comprise at least one gear wheel 22 locked together in rotation to the winding/unwinding member 14 around the winding/unwinding axis R and provided with a plurality of teeth 24 arranged circumferentially the one with respect to the other.

Specifically, the gear wheel 22 and the winding/unwinding member 14 rotate locked together and coaxially with each other on the rotational pin 15.

In addition, the gear wheel 22 is positioned between the first housing portion 16a and the second housing portion 16b.

In this regard, the gear wheel 22 comprises at least one fitting slot 22a into which the intermediate stretch 12 is fitted.

Given the arrangement of the gear wheel 22, it is easy to appreciate that the fitting slot 22a is also positioned between the first housing portion 16a and the second housing portion 16b.

Preferably, the fitting slot 22a has substantially U-shaped conformation.

In this regard, the fitting slot 22a can be sized with a thickness substantially coincident with that of the intermediate stretch 12.

In this way, in fact, the intermediate stretch 12 is fitted to size in the fitting slot 22a and remains fixed in position within the fitting slot itself even as a result of rotations of the winding/unwinding member 14 in opposite directions around the winding/unwinding axis R.

Fitting slots 22a of different size and conformation, e.g. provided with a larger size than that of the intermediate stretch 12, cannot however be ruled out.

It is specified, in this regard, that the special expedient of providing a fitting slot 22a positioned between the first housing portion 16a and the second housing portion 16b allows for the winding and unwinding of the first stretch 10 and the second stretch 11 in a decidedly simple and efficient manner.

In fact, simply bending the cable 5, attaching the intermediate stretch 12 to the fitting slot 22a and winding the first stretch 10 and the second stretch 11 onto the first housing portion 16a and the second housing portion 16b, respectively, is enough to make winding and unwinding the first stretch 10 and the second stretch 11 completely smooth and intuitive.

In fact, if, for example, the first end 6 and/or the second end 7 are pulled to unwind the cable 5, the latter exerts a thrust on the gear wheel 22 that sets it in rotation together with the winding/unwinding member 14 in the first direction of rotation, unwinding the first stretch 10 and the second stretch 11. In this regard, it is specified that in the first embodiment the fitting slot 22a is developed between the teeth 24 and the housing area 16.

In actual facts, the fitting slot 22a lies, by its entire length, between the bottom circumference of the gear wheel 22 (also called “foot circumference”, i.e., the circumference that touches the teeth 24 below) and the housing area 16 (see FIG. 4).

Recalling that the winding/unwinding axis R is superimposed on the geometric axis of the housing area 16 it is, therefore, possible to state that the intermediate stretch 12 is located at a distance from it roughly similar to that of the first stretch 10 and of the second stretch 11 (or, possibly, a little higher depending on the length of the fitting slot 22a).

In the second embodiment, however, the intermediate stretch 12 is positioned between the stretches 10, 11 and the winding/unwinding axis R, that is, it is closer to the winding/unwinding axis R than the latter.

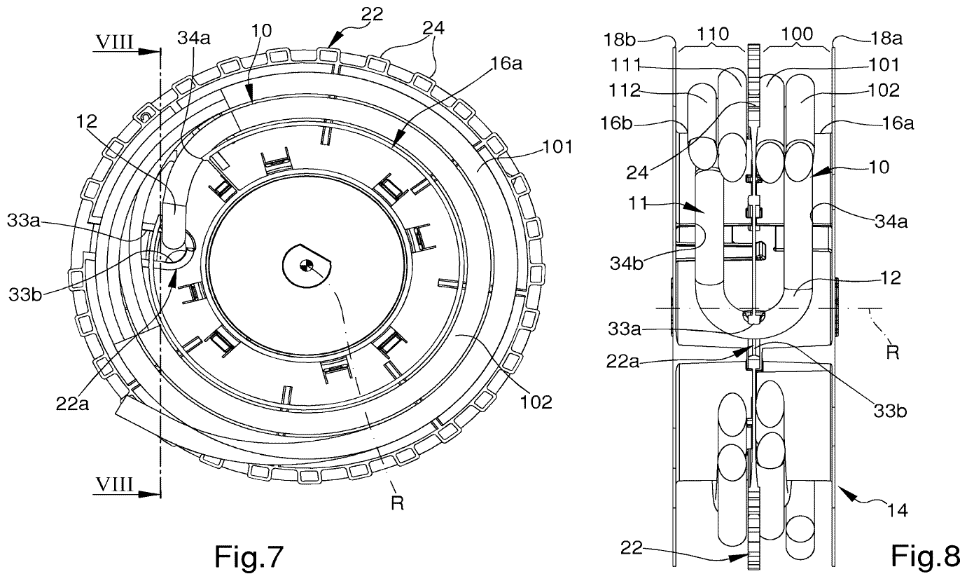

In this regard, in this second embodiment the fitting slot 22a has a longer length than in the first embodiment and is, in particular, divided into:
a head portion 33a arranged between the teeth 24 and the housing area 16; and
a bottom portion 33b, to which the intermediate stretch 12 is attached, arranged between the housing area 16 and the winding/unwinding axis R (see FIGS. 7, 8 and 9 in this regard).

Substantially, the head portion 33a is located between the bottom circumference of the gear wheel 22 and the housing area 16, while the bottom portion 33b is located between the latter and the rotational pin 15.

In other words, the distance of the head portion 33a from the winding/unwinding axis R is greater than that of the housing area 16, while the distance of the bottom portion 33b from that axis is less than that of the housing area 16.

In actual facts, the housing area 16 is positioned between the head portion 33a and the bottom portion 33b.

In order for the intermediate stretch 12 to fasten to the bottom portion 33b, the first housing portion 16a and the second housing portion 16b have, respectively, a first passage opening 34a and a second passage opening 34b between which the intermediate stretch 12 is located.

In actual facts, a first end of the intermediate stretch 12 is communicating with the first stretch 10 at the first passage opening 34a, while the other end of the intermediate stretch 12 is communicating with the second stretch 11 at the second passage opening 34b.

It is worth noting that providing such a way of winding the cable 5 allows the latter to be wound/unwound on the winding/unwinding member 14 without causing, in doing so, any friction between its coils as well as any stress on the intermediate stretch 12.

This peculiar feature allows the adoption of standard cables approved directly by car manufacturers or by the cable manufacturer itself (by way of non exclusive example IEC 62196 Type 2 Mennekes) without making any changes to the cable itself, thus safeguarding its electrical and mechanical characteristics and service life.

This clearly reduces the wear and tear and, consequently, the frequency with which the cable 5 and other components of the case 1 require maintenance.

That being said, the possibility cannot be ruled out that the case 1 lacks the fitting slot 22a and has, instead, at least one fitting hole of the intermediate stretch 12 placed, in the first embodiment, between the teeth 24 and the housing area 16 and, in the second embodiment, between the housing area 16 and the winding/unwinding axis R.

In all cases, in both embodiments, the first stretch 10 and the second stretch 11 define, respectively, a plurality of primary coils 100 wound on the first housing portion 16a and a plurality of secondary coils 110 wound on the second housing portion 16b.

More specifically, the primary coils 100 comprise at least one first primary coil 101 and at least one second primary coil 102 side by side on the first housing portion 16a.

Similarly, the secondary coils 110 comprise at least one first secondary coil 111 and at least one second secondary coil 112 side by side on the second housing portion 16b.

In other words, the first stretch 10 and the second stretch 11 are wound on the first housing portion 16a and on the second housing portion 16b, respectively, to define, on the latter, at least two complete turns.

Different embodiments cannot however be ruled out wherein the number of coils is different from the reported one.

Specifically, the first primary coil 101 is placed between the first secondary coil 111 and the second primary coil 102, while the first secondary coil 111 is placed between the first primary coil 101 and the second secondary coil 112.

In other words, the first coils 101, 111 are placed between the gear wheel 22 (which, as mentioned, is itself positioned between the housing portions 16a, 16b) and the second coils 102, 112.

That said, in the second embodiment the intermediate stretch 12 is positioned in connection between the second primary coil 102 and the second secondary coil 112.

In actual facts, the intermediate stretch 12 is connected to the outermost coils, i.e., those arranged furthest from the gear wheel 22 in a direction parallel to the winding/unwinding axis R.

To understand the advantageous feature of this fact, it must be considered that excessive bending of the intermediate stretch 12 could result in serious damage to the cable 5, consequently forcing premature repair and/or replacement of the latter, especially in the case of cables of significant diameter.

Keeping this in mind, the special expedient of positioning the intermediate stretch 12 between the second coils 102, 112 makes it possible to reduce the curvature of the intermediate stretch itself and, therefore, the probability of prematurely ruining the cable 5.

In this sense, it is easy to appreciate how the technical expedient just described operates synergistically with the fact that the intermediate stretch 12 is located at a shorter distance from the winding/unwinding axis R than the stretches 10, 11 in reducing the overall wear of the cable 5 and, therefore, increasing the durability of the latter.

This expedient allows, therefore, the adoption of type-approved cables (e.g., IEC 62196 Type 2 Mennekes), guaranteeing them their entire service life established during type approval.

The securing means 22, 23 comprise, in addition, at least one securing pin 23 insertable between the teeth 24 to stop the rotation of the gear wheel 22 and of the winding/unwinding member 14 around the winding/unwinding axis R.

In fact, the securing pin 23 has a thickness substantially coincident with the space defined between two adjacent teeth 24 and, therefore, can be inserted to size between them, interfering with the rotation of the gear wheel 22 and consequently stopping the latter and the winding/unwinding member 14.

It is easy to appreciate at this point that the particular expedient of providing securing means 22, 23 for the rotation of the winding/unwinding member 14 makes it possible to inhibit the return action of the return means 19a, 19b on the winding/unwinding member itself and, therefore, to arrange the latter stably in any configuration, even a different one from the configuration of maximum winding.

For example, in this way, it is possible to arrange the winding/unwinding member 14 stably in the configuration of maximum unwinding, thus making sure that the return means 19a, 19b do not rewind the cable 5 by returning the winding/unwinding member 14 to the configuration of maximum winding.

This fact proves particularly advantageous, among other things, to avoid unwanted rewinding of the cable 5 on the winding/unwinding member 14, e.g., when the first connector 8 and the second connector 9 are connected to the electric charging device D and to the inlet P of the vehicle A, respectively.

In this circumstance, in fact, the elastic return force exerted by the return means 19a, 19b on the winding/unwinding member 14 could result in a disconnection of at least one of either the first connector 8 or the second connector 9 from the electric charging device D and from the inlet P of the vehicle A, respectively.

Ultimately, therefore, providing for securing means 22, 23 allows electric charging to be carried out in a completely smooth and safe manner.

Advantageously, the securing means 22, 23 comprise lifting and lowering means 25, 26 for lifting and lowering the securing pin 23 movable along a lifting and lowering direction Y between at least one lowered position, wherein the securing pin 23 is fitted between the teeth 24, and at least one lifted position, wherein the securing pin 23 is disengaged from the teeth 24.

Specifically, the lifting and lowering direction Y is transverse to the winding/unwinding axis R.

More specifically, the lifting and lowering direction Y is substantially orthogonal to the winding/unwinding axis R.

Specifically, in the first embodiment, the lifting and lowering direction Y is skewed with respect to the winding/unwinding axis R.

In other words, the lifting and lowering direction Y is deviated from the winding/unwinding axis R, that is, it does not define any intersection point therewith.

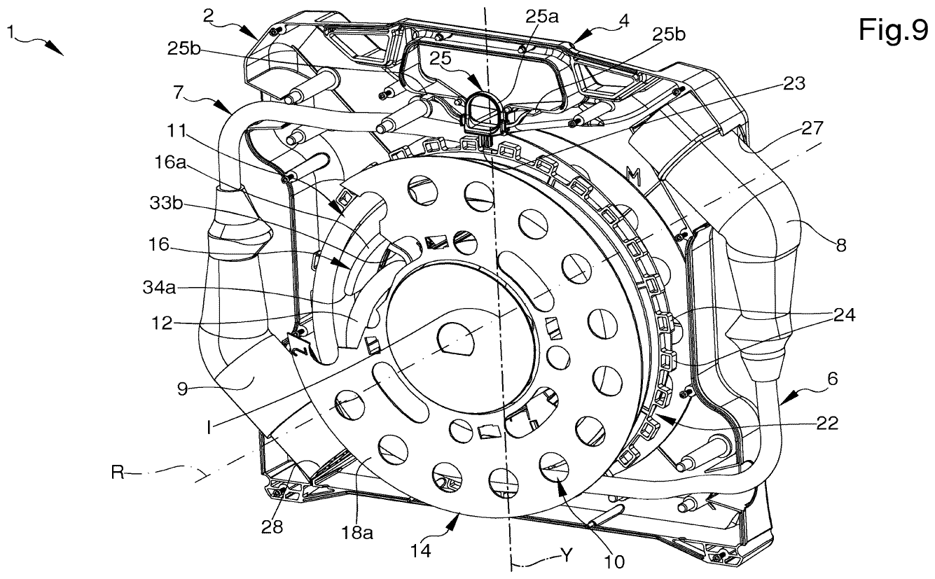

In the second embodiment, on the other hand, the lifting and lowering direction Y is incident to the winding/unwinding axis R and, therefore, defines an intersection point I therewith (see FIG. 9).

This geometric relationship ensures a particularly effective clamping since it allows the securing pin 23 to fit substantially completely between one tooth 24 and the next, thus averting the risk that the securing pin 23 might unintentionally disengage from the gear wheel 22.

In particular, the lifting and lowering means 25, 26 comprise at least one control element 25 positioned on the container 2 and manually activated to move the securing pin 23 between the lifted position and the lowered position.

In this case, the control element 25 is associated with the handle 4.

Specifically, in the first embodiment of the case 1 the control element 25 is of the type of a button protruding from the handle 4. (FIG. 4)

In this regard, the control element 25 is pressure-activated to move the securing pin 23 from the lowered position to the lifted position and is releasable to move the securing pin 23 from the lifted position to the lowered position.

For the purpose of facilitating the repositioning of the securing pin 23 to the lowered position when the control element 25 is released, the lifting and lowering means 25, 26 comprise at least one positioning spring 26 associated with the securing pin 23 and with the container 2.

In actual facts, the positioning spring 26 is a compression spring that is progressively compressed by the securing pin 23 moving from the lowered position to the lifted position.

In doing so, the positioning spring 26 accumulates elastic energy as its length is reduced.

By releasing the control element 25, the securing pin 23 no longer exerts any force on the positioning spring 26 and the latter, therefore, releases the accumulated spring energy, placing the securing pin 23 in the lowered position and thus returning its length to its pre-compression value.

Alternatively, as visible in FIGS. 5, 6, and 9, the control element 25 has a ring portion 25a that can be pulled by the user to move the securing pin 23 from the lowered position to the lifted position and released by the user to move the securing pin 23 from the lifted position to the lowered position.

In this case, the control element 25 comprises at least one repositioning portion 25b associated with the ring portion 25a and adapted to counteract the switch of the securing pin 23 from the lowered position to the lifted position.

In actual facts, the repositioning portion 25b is configured to facilitate the return of the securing pin 23 to the lowered position if it is arranged by the user in the lifted position.

Specifically, the repositioning portion 25b is elastically deformable.

Specifically, the repositioning portion 25b gains elastic energy when the securing pin 23 moves from the lowered position to the lifted position and releases the previously accumulated elastic energy when the securing pin 23 moves from the lifted position to the lowered position.

As visible in the aforementioned figure, the control element 25 preferably comprises two repositioning portions 25b.

In particular, the repositioning portions 25b protrude in opposite directions with respect to the ring portion 25a.

In this case, the repositioning portions 25b are of the flexible fin type.

Embodiments of lifting and lowering means 25, 26 of a different type from that just described, for example, lifting and lowering means 25, 26 lacking the positioning spring 26 cannot, in all cases, be ruled out.

It is emphasized at this point that providing manually controllable lifting and lowering means 25, 26 is particularly advantageous in order to be able to connect the first connector 8 and the second connector 9 in a completely intuitive and simple way.

For example, it is sufficient for the user to connect the first connector 8 to the electric charging device D and, by activating the control element 25 to lift the securing pin 23, move towards the vehicle A.

By operating in this way, in fact, the rotation of the winding/unwinding member 14 is allowed and the cable 5 can be unwound as the user approaches the vehicle A.

Once unwound to a sufficient length, e.g. corresponding to that obtained when the user is positioned substantially halfway between the electric charging device D and the vehicle A, the second connector 9 can also be connected to the inlet of the vehicle A.

At this point, the user can place the container 2 on the ground by releasing the control element 25 to lower the securing pin 23 and thereby to prevent the winding/unwinding member 14 from rotating.

By doing so, in fact, the return means 19a, 19b exert no elastic return force on the winding/unwinding member 14 and, therefore, the cable 5 is kept slack.

When electrical charging is completed, the user need only disconnect the first connector 8 and the second connector 9 and press the control element 25 again to allow the cable to be automatically rewound on the winding/unwinding member 14 due to the action of the return means 19a, 19b.

In this way, in fact, the winding/unwinding member 14 is returned to the configuration of maximum winding and the case 1 can be lifted off the ground and moved, e.g., stored in the trunk of the vehicle A.

From the foregoing, it is readily apparent that the case 1 allows the rotation of the winding/unwinding member 14 to be blocked and released quite quickly and intuitively as a result of gripping and resting the case on the ground, respectively.

By virtue, therefore, of its construction, that is, the fact of having a container 2 and a handle 4 of the same, the case 1 proves to be absolutely advantageous in making the above operations decidedly easy to carry out, to the benefit of the convenience, simplicity and rapidity with which the vehicle A can be charged.

In this regard, it should be added that control elements 25 arranged in different positions on the container 2, such as arranged below it, cannot be ruled out.

In fact, this particular arrangement allows the securing pin 23 to be moved between the lifted and lowered positions in a fully automatic manner, without, that is, direct manual intervention by the user.

Specifically, once the first connector 8 and the second connector 9 are connected and the case 1 is arranged substantially in the middle between the electric charging device D and the vehicle A, it is sufficient to place the container 2 on the ground to activate the control element 25 by pressure on the ground.

By doing so, the securing pin 23 is placed in the lifted position, blocking the rotation of the winding/unwinding member 14 around the winding/unwinding axis R.

After the electrical charging is completed, the user needs only disconnect the first connector 8 and the second connector 9 and lift the container 2 off the ground to deactivate the control element 25 and arrange the securing pin 23 in the lowered position, allowing the cable to be automatically rewound onto the winding/unwinding member 14 due to the action of the return means 19a, 19b.

It should be specified that even in the configuration of maximum winding, the first connector 8 and the second connector 9 are arranged outside the container 2.

It is easy to appreciate how this fact enables the user to grip the connectors 8, 9 with ease and immediacy and to store them, following use, just as quickly and intuitively.

In this regard, the case 1 comprises at least one first housing 27 and at least one second housing 28 associated with the container 2 and adapted to house the first connector 8 and the second connector 9, respectively, when the winding/unwinding member 14 is in the configuration of maximum winding of the cable 5.

In detail, the first housing 27 and the second housing 28 have complementary conformation to the first connector 8 and to the second connector 9, respectively.

This means that the shape of the housings 27, 28 corresponds to that of connectors approved for AC charging (e.g. IEC 62196 Type 2 Mennekes).

Preferably, the container 2 comprises:
at least a first perimeter face 29 where the first housing 27 is located; and
at least a second perimeter face 30, opposite the first perimeter face 29 and substantially parallel to the latter, where the second housing 28 is located, the compartment 3a, 3b being positioned between the first perimeter face 29 and the second perimeter face 30.

The first perimeter face 29 and the second perimeter face 30 are located in close proximity to the first end 6 and to the second end 7 in the configuration of maximum winding; therefore, the insertion of the first connector 8 and of the second connector 9 into the first housing 27 and into the second housing 28, respectively, can be done easily and immediately.

Conveniently, the lifting and lowering direction Y and the winding/unwinding axis R define a median plane, the first housing 27 and the second housing 28 being arranged in opposite positions to each other on the container 2 with respect to the median plane.

Preferably, the first housing 27 and the second housing 28 are of the type of pockets cut out on the container 2.

In fact, this solution makes it possible to significantly reduce the overall dimensions of the case 1.

That being said, it cannot be ruled out that the first housing 27 and the second housing 28 could be made differently, e.g., they could be of the type of protrusions each provided with a cavity into which the first connector 8 and the second connector 9 could be fitted, respectively.

More specifically, the first housing 27 and the second housing 28 are of such a size that the first connector 8 and the second connector 9 can be fitted to size inside them.

This allows the first connector 8 and the second connector 9 to be housed firmly and stably in the first housing 27 and in the second housing 28.

In this way, the overall dimensions of the case 1 are greatly reduced and the case itself is, for the above reason, easily placed inside the trunk or special compartments.

This fact thus facilitates the handling of the case 1 and ensures that the first connector 8 and the second connector 9, remaining firmly inserted in their respective housings, do not bump into external bodies and/or surfaces and, in doing so, end up damaged.

It has in practice been ascertained that the described invention achieves the intended objects.

In particular, the fact is emphasized that providing a transportable case which can rest on the ground inside which a single electric charging cable can be wound and unwound allows for an easily transportable cable holder case for BEV or PHEV vehicles, which allows simplifying handling, connecting and disconnecting the electric cable during the charging operations of the electric vehicle.

Not only that, but in this way it is also possible to carry out the electric charging while keeping the cable lifted off the ground at all times during the entire operation.

This keeps the cable clean even after charging is complete, allowing it to be rewound and repositioned inside the vehicle hygienically and without leading to soiling of people and/or surfaces.

In addition, the described case allows the adoption and installation of charging cables already approved by car manufacturers (or by the cable manufacturer itself) according to industry standards and regulations, without affecting their electrical, mechanical properties and service life in any way, and without the need for further approval of the case itself.

Finally, the fact is emphasized that providing for a first winding/unwinding element and a second winding/unwinding element that can be rotated together in combination with a fastening slot located between the first housing portion and the second housing portion allows winding/unwinding of the first stretch and of the second stretch from/onto the winding/unwinding member to be carried out in a completely intuitive and efficient manner, averting the possibility of cable knots.

1. Cable holder case (1) for vehicles, characterized by the fact that it comprises:
at least one transportable container (2) resting on the ground and defining at least one containment compartment (3a, 3b) inside it;
a single cable (5) for electrically charging electrically driven vehicles which is housed at least partly inside said compartment (3a, 3b) in a winding and unwinding manner and comprises at least two movable ends (6, 7) located externally to said compartment (3a, 3b), of which:
at least one first end (6) provided with at least one first connector (8) connectable to at least one electric charging device (D); and
at least one second end (7), opposite said first end (6), provided with at least one second connector (9) connectable to at least one inlet (P) of at least one electrically driven vehicle (A);
winding/unwinding means (13) which are associated with said container (2) and are adapted to wind and unwind said cable (5).

2. Case (1) according to claim 1, characterized by the fact that said winding/unwinding means (13) comprise at least one winding/unwinding member (14) around which said cable (5) is wound which is associated with said container (2) in a rotatable manner around at least one winding/unwinding axis (R) of said cable (5).

3. Case (1) according to claim 2, characterized by the fact that:
said cable (5) comprises at least one first stretch (10) associated with said first end (6) and at least one second stretch (11) substantially parallel to said first stretch (10) associated with said second end (7);
said winding/unwinding member (14) comprises at least one housing area (16) around which said first stretch (10) and said second stretch (11) are wound.

4. Case (1) according to claim 3, characterized by the fact that said housing area (16) comprises at least one first housing portion (16a) on which said first stretch (10) is wound and at least one second housing portion (16b), alongside said first housing portion (16a), on which said second stretch (11) is wound.

5. Case (1) according to claim 1, characterized by the fact that said winding/unwinding member (14) is rotatable around said winding/unwinding axis (R) between at least one configuration of maximum winding of said cable (5) and at least one configuration of maximum unwinding of said cable (5), and that said winding/unwinding means (13) comprise return means (19a, 19b) associated with said winding/unwinding member (14) and adapted to place the latter in said configuration of maximum winding.

6. Case (1) according to claim 1, characterized by the fact that said return means (19a, 19b) comprise at least one return element (19a, 19b) which is elastically deformable by traction and is provided with at least one fixed portion (20a, 20b), associated with said container (2), and with at least one movable portion (21a, 21b), opposite said fixed portion (20a, 20b), associated with said housing area (16) and movable between said configuration of maximum winding and said configuration of minimum winding.

7. Case (1) according to claim 6, characterized by the fact that said return element (19a, 19b) is of the type of a strip spring.

8. Case (1) according to claim 6, characterized by the fact that it comprises at least one containment member (31a, 31b) of said return element (19a, 19b) adapted to contain the latter to size and by the fact that said winding/unwinding member (14) defines at least one seat (32a, 32b) of said containment member (31a, 31b).

9. Case (1) according to claim 1, characterized by the fact that said winding/unwinding means (13) comprise securing means (22,

23. for securing the rotation of said winding/unwinding member (14) around said winding/unwinding axis (R).

10. Case (1) according to claim 9, characterized by the fact that said securing means (22, 23) comprise:
at least one gear wheel (22) locked together in rotation to said winding/unwinding member (14) around said winding/unwinding axis (R) and provided with a plurality of teeth (24) arranged circumferentially the one with respect to the other;
at least one securing pin (23) insertable between said teeth (24) to stop the rotation of said gear wheel (22) and of said winding/unwinding member (14) around said winding/unwinding axis (R).

11. Case (1) according to claim 10, characterized by the fact that:
said cable (5) comprises at least one intermediate stretch (12) positioned between said first stretch (10) and said second stretch (11); and that
said gear wheel (22) comprises at least one fitting slot (22a) into which said intermediate stretch (12) is fitted.

12. Case (1) according to claim 11, characterized by the fact that said intermediate stretch (12) is positioned between said stretches (10, 11) and said winding/unwinding axis (R).

13. Case (1) according to claim 12, characterized by the fact that:
said first stretch (10) comprises a first primary coil (101) and a second primary coil (102) side by side to each other;
said second stretch (11) comprises a first secondary coil (111) and a second secondary coil (112) side by side to each other;
wherein said first primary coil (101) is placed between said first secondary coil (111) and said second primary coil (102), said first secondary coil (111) is placed between said first primary coil (101) and said second secondary coil (112) and wherein said intermediate stretch (12) is placed in connection between said second coils (102, 112).

14. Case (1) according to claim 1, characterized by the fact that said securing means (22, 23) comprise lifting and lowering means (25, 26) for lifting and lowering said securing pin (23) movable along a lifting and lowering direction (Y) between at least one lowered position, wherein said securing pin (23) is fitted between said teeth (24), and at least one lifted position, wherein said securing pin (23) is disengaged from said teeth (24).

15. Case (1) according to claim 14, characterized by the fact that said lifting and lowering direction (Y) is skewed with respect to said winding/unwinding axis (R).

16. Case (1) according to claim 14, characterized by the fact that said lifting and lowering direction (Y) is substantially orthogonal and incident to said winding/unwinding axis (R)

17. Case (1) according to claim 15, characterized by the fact that said lifting and lowering means (25, 26) comprise at least one control element (25) positioned on said container (2) and manually activated to move said securing pin (23) between said lifted position and said lowered position.

18. Case (1) according to claim 1, characterized by the fact that it comprises at least one first housing (27) and at least one second housing (28) which are associated with the container (2) and are adapted to house said first connector (8) and said second connector (9) respectively when said winding/unwinding member (14) is in said configuration of maximum winding of said cable (5).

19. Case (1) according to claim 18, characterized by the fact that said lifting and lowering direction (Y) and said winding/unwinding axis (R) define a median plane and by the fact that said housings (27, 28) are arranged in opposite positions to each other on said container (2) with respect to said median plane.
